(19) United States
(12) Patent Application Publication
(10) Pub. No.: US 2004/0182221 A1
(43) Pub. Date: Sep. 23, 2004

(54) Contoured stringed musical instrument

(76) Inventor: Leo L. Burrell, Huntington, WV (US)

Correspondence Address: ROBERT R. WATERS, ESQ., WATERS LAW OFFICE, PLLC, 633 SEVENTH STREET, HUNTINGTON, WV, 25701, US

(21) Appl. No.: 10/769,031

(22) Filed: Jan. 30, 2004

Related U.S. Application Data
(60) Provisional application No. 60/444,226, filed on Jan. 31, 2003.

(51) Int. Cl. G10D 3/00

(52) U.S. Cl. 84/291

(57) ABSTRACT

A stringed instrument featuring one or more contoured surfaces is claimed. The instrument features a body with a neck that supports strings tautly oriented across the front face of the instrument. Either the front, back, or both faces of the instrument are contoured or skewed such as to improve the ergonomic aspects of the instrument. In use, the ergonomic design facilitates a user reaching over the back top side to strum the strings, and allows the whole instrument to be rolled slightly towards the user at the top side. This also effectively tilts the string supporting neck in an ergonomically effective manner. The skewed body may be curved at its ends or have essentially straight ends skewed from each other.

### CROSS-REFERENCE TO RELATED APPLICATIONS

This application claims priority from U.S. Provisional Application 60/444,226, filed on Jan. 31, 2003. This Application relates to a stringed musical instrument with a contoured neck and body resulting in an ergonomic design. The entire disclosure contained in U.S. Provisional Application 60/444,226, including the attachments thereto, is incorporated herein by reference.

### FIELD OF THE INVENTION

This invention relates generally to stringed musical instruments, and specifically a stringed musical instrument such as a guitar or the like which features a contoured and skewed body and fret board, rotated about the central longitudinal axis of the instrument.

### BACKGROUND OF THE INVENTION

Stringed musical instruments have long been available in the entertainment industry and come in a variety of forms. Many of the most popular stringed instruments are designed to be played while holding the instrument in a generally horizontal position against the body of the user. Such an instrument features a body consisting of a hollow cavity, often with a sound hole disposed in the center. In addition, a neck assembly extends from one end of the body and generally supports and anchors a series of strings which are oriented to cross the center of the instrument near or about the longitudinal axis. Instruments of this type include the guitar, banjo, mandolin, and variations thereof.

One of the more popular stringed musical instruments is the guitar. The guitar is generally formed of a hollow body consisting of two planes constructed of wood, polymer, or the like, separated by an exterior wall extending around the edge of the guitar to couple with the two faces of the instrument to define a generally hollow body. Extending from one end of the hollow body is a long neck assembly with an attached fret board extending the length of the neck terminating in a headstock. A series of six or more strings are anchored to the bridge at the base of the guitar, and said strings are oriented first across the saddle on the bridge, then across the sound hole and upward to the headstock where they are attached through tuning pegs at the end of the headstock. The strings are tightened with the tuning pegs which vary the degree of resistance, whereby the strings may be made more taut. By turning the tuning pegs, the strings may be tightened or loosened. In general, conventional guitar assemblies feature a construction wherein the six or more strings are held in a parallel position with respect to the surface of the face of the guitar, and equidistant from each other.

The six or more strings used in a guitar range in gauge and diameter to effect different tonal qualities. In operation, the musician will depress the strings upon the frets in various combinations with one hand and strum, pick, or otherwise manipulate the strings with the other hand in order to produce a sound.

A user will need to manipulate the strings with great skill in order to produce an aesthetically pleasing guitar performance. Due to the location of the strings, neck and face of the guitar, it is difficult to manipulate one's wrist and fingers such as to apply the various guitar chords and maneuver among chords with relative ease. Accordingly, playing a guitar is ergonomically challenging to the wrist and fingers of a user and especially to a beginning user.

The repetitive playing of a guitar can result in significant injuries to the hand and particularly the wrist of the user. The movement of the chords requires continuous and often complex finger, hand, and wrist movement. In addition, the depression of strings against the fret board while chording results in an awkward and unusual degree of wrist flexion. Excessive wrist flexion over a period of time is known to cause repetitive strain injuries such as Tendinitis and Carpel Tunnel Syndrome.

### DESCRIPTION OF THE PRIOR ART

Since guitars are long known in the art, a wide assortment of guitar assemblies and specific embodiments of guitars and other stringed instruments are available in the patent art. Although most feature a parallel plane arrangement of the strings with respect to the guitar face, some guitars have featured twisted necks or altered spatial relationships between the strings and the fretboard of the guitar. One such prior art patent is U.S. Pat. No. 4,534,260 by the present inventor, Leo L. Burrell. This earlier invention set forth a stringed musical instrument wherein the neck of the instrument has been altered such that one end of the neck and fretboard are twisted about the longitudinal axis of the instrument. Each string of the instrument was held in a skewed alignment relative to one or more of the other strings supported by the assembly. Accordingly, the guitar resulted in a string location that was much more convenient to the user as the strings were within easier reach of the chord hand.

Other stringed instruments have been set forth in patents and literature since the Burrell patent, which also feature neck and body alterations of varying degrees. For example, U.S. Pat. No. 5,852,249 by Steinberg et al. features a mild modification over Burrell '260 wherein the string support medium along the fret board has been elongated commensurate with the twisted neck of the guitar. In contrast, U.S. Pat. No. 5,696,337 by Hall features a fret board that is uniformly concave with respect to the user's fingers. U.S. Pat. No. 5,018,423 by Bunker et al. features a neck adjustment means, wherein the neck may be adjusted up or down or rotationally.

Looking specifically at the body of a stringed instrument, several patents discuss or claim ergonomic improvements of varying scope. U.S. Pat. No. 6,034,308 by Little is directed to an ergonomic string instrument wherein both the bridge and the nut are rotated about a longitudinal axis in order to reduce the incidence of overuse or injury due to extreme wrist flexion. U.S. Pat. No. 6,573,439 by Wilson claims an ergonomic guitar featuring extensive modifications to the body. These changes include an adjustable and locking mechanism for a guitar leg rest. In addition, design patents Des. No. 422,015 and Des. No. 431,589 by Steinberg et al. claim ornamental arrangements for modified guitar bodies.

Despite some improvement or modification in the design of a standard stringed instrument such as a guitar, prior art devices still feature a general arrangement that is not ergonomically optimal. In particular, prior art devices require a chording position that is significantly removed from the strumming hand, and chord positions that are difficult on the wrist and fingers. In addition, the body of a guitar has historically featured a somewhat rectangular profile wherein the body was essentially constructed of two parallel walls separated several inches from each other to form a sound cavity. Since a user is required to hold the instrument against his body while playing, the flat parallel wall arrangement for the body of the guitar is not particularly helpful. As such, users often need to stoop or hold their arms at an unnatural distance in front of their body to appropriately reach the strings. What is needed in the art is a guitar in which the guitar body may be altered such as to make it conform to the shape of the human body to aid in holding and playing the instrument, while also accommodating and complementing a twisted neck and fretboard arrangement.

### SUMMARY OF THE INVENTION

In view of the foregoing disadvantages inherent in the pre-existing guitar devices and other stringed instrument constructions, the present invention provides a significant improvement. As such, the general purpose of the present invention, which will be described subsequently in greater detail and shown fully in the attached drawings, is to provide a new and improved structural arrangement for a stringed musical instrument to improve both sound performance and ergonomic performance.

In order to achieve this general objective, the present invention consists essentially of a stringed musical instrument in which the neck of the instrument has been skewed or altered such as to tilt toward the user at the top and flare generally from the user at the base of the neck. In addition, the instrument is characterized by a sound cavity in which both of the primary walls of the instrument have been altered to aid in the arm movement of the user toward the fret board. As such, the back side of the guitar features a slight wrapping wherein the back wall of the instrument may be described as convex with respect to the user. Accordingly, as a user holds the instrument, it will be easier to bend forward, across the body of the instrument and reach the chords with the chording hand. The opposite wall of the instrument—the wall featuring the sound hole—is also contoured somewhat with respect to the position of the user. Accordingly, both the neck of the instrument and hollow body of the instrument will be skewed and twisted with respect to the position of the user.

It is a primary objective of the present invention to provide for a stringed musical instrument that is much more ergonomically pleasing than prior art devices.

It is a further objective of the present invention to provide a stringed musical instrument that is much easier to learn for a musician as compared to conventional devices. Accordingly, the sound performance of the present invention will be greatly improved as it will be easier for a user to achieve greater skill in a shorter period of experience time.

It is a further objective of the present invention to provide a stringed musical instrument that is aesthetically pleasing and which presents a uniform twisting between the neck and body of the instrument.

There has thus been outlined in a broad sense, the more important features of the present invention in order that the detailed description thereof that follows may be better understood, and in order that the present contribution to the art may be better appreciated. There are, of course, additional features of the invention that will be described hereafter which will form the subject matter of the invention.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may be readily utilized as a basis for the designing of other structures, methods, and apparatus for carrying out the purpose of the invention.

### BRIEF DESCRIPTION OF THE DRAWINGS

Additional utility and features of the invention will become more fully apparent to those skilled in the art by reference to the following drawings, which thoroughly illustrate the primary features of the present invention.

FIG. 1 is a top view of a typical stringed instrument constructed according to the present invention, and specifically a guitar constructed according to the present invention.

FIG. 2 is a side view of a guitar constructed according to the present invention, showing the contoured body arrangement and neck arrangement.

FIG. 3 is a side view of a guitar constructed according to the present invention. The side of the guitar shown in FIG. 3 is the opposite side in comparison to the side shown in FIG. 2.

FIG. 4 is a perspective view of the present invention showing one side and the back of a guitar constructed according to the present invention.

FIG. 5 is an end view of a guitar constructed according to the present invention, as viewed from the end opposite the string support neck.

FIG. 6 is an end view of a guitar constructed according to the present invention, taken from the neck end of the guitar, with the drop portion of the neck cut away to fully show the body.

FIG. 7 is an overhead view of a person holding and playing a guitar constructed according to the present invention.

FIG. 8 is a perspective view of a guitar constructed according to the current invention.

FIG. 9 is a back view of a guitar constructed according to the current invention.

### DETAILED DESCRIPTION OF THE

### PREFERRED EMBODIMENT

The contoured stringed instrument arrangement of the present invention can be utilized in a variety of specific musical instrument embodiments. The detailed description below is for a preferred embodiment in which the specific musical instrument is a six-string acoustic guitar. Specifically, the embodiment shown in the drawings and discussed below features contouring for the benefit of a right-handed user of a six string acoustic guitar. While this embodiment lends itself to right-handed use, a left handed guitar or other stringed instrument could also be produced with the appropriate changing of the location of the contouring. It is to be understood that a variety of other arrangements are also possible without departing from the spirit and scope of the invention.

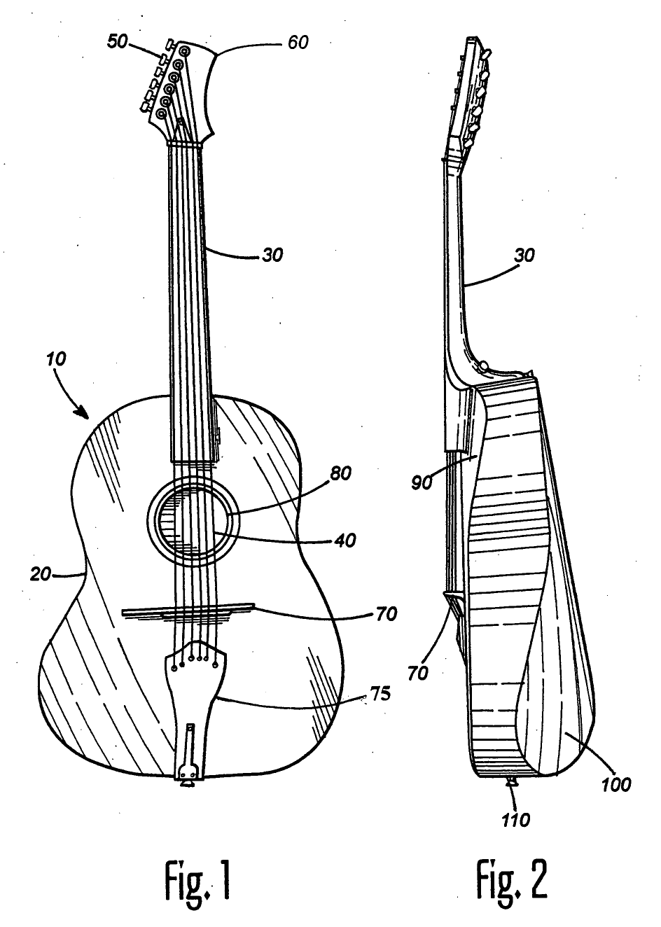

Referring to FIG. 1 and FIG. 2, an acoustic guitar (10) is shown which includes the standard elements of a body (20), an elongated string support or neck assembly (30), six strings (40) arranged in parallel stretching from the tuning pegs (50) of the headstock (60) over the bridge (70) to the tailpiece (75). The strings are held in tension across the bridge and sound hole of the guitar. Although a tailpiece is shown in FIG. 1, other anchoring mechanisms may be utilized including a fixed bridge or a bridge and pin block arrangement.

The guitar (10) of FIG. 1 consists of two contoured face members, a front (90) and a back (100), separated by an exterior wall (110) extending around the edge of the guitar. As can be clearly seen in FIG. 1, the bridge (70) of the guitar (10) has been skewed somewhat with respect to the longitudinal axis of the instrument such as to depart from the prior art arrangement wherein the bridge was arranged at a somewhat perfect right angle, perpendicular to the longitudinal axis of the instrument.

FIG. 3 shows a side view of the preferred embodiment of the present invention. As can be clearly seen in the Figure, the top face portion (90) of the guitar is contoured such as to approach or turn toward the user at the rear top edge of the instrument. In addition, the back surface (100) of the instrument is also contoured, resulting in an instrument with a significantly altered spacial profile of the interior cavity. As can be further seen in the Figure, the shape of the guitar edge varies significantly from a maximum at the approximate center of the guitar, reducing in dimension as either end of the guitar is approached.

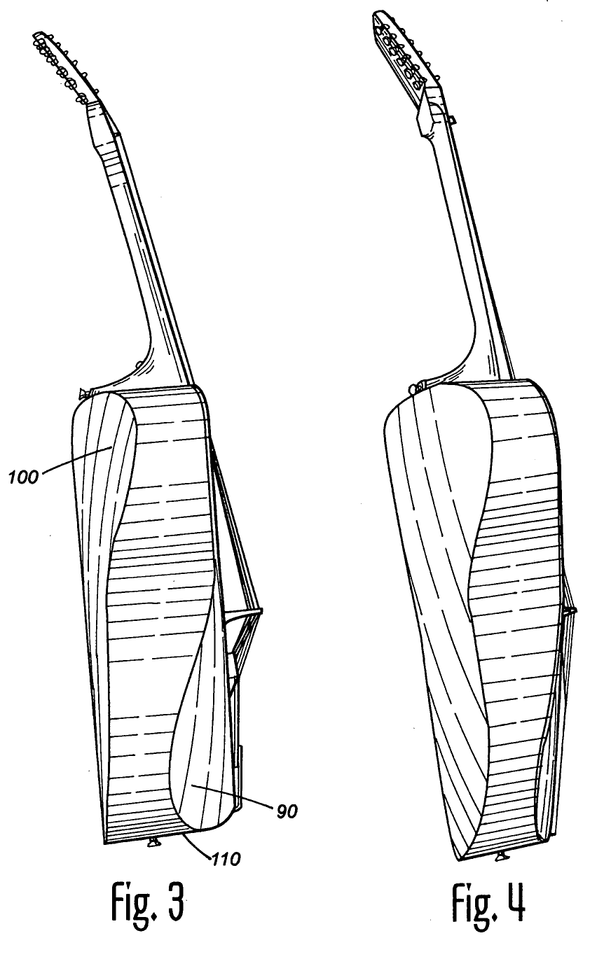

The previous view of FIG. 2 shows the opposite side view of FIG. 3 of a guitar constructed according to the present invention. As is the case with FIG. 3, FIG. 2 shows that the front and back side of the guitar have each been altered from the typical parallel construction such as to create a spacial profile of the enclosed area of the guitar which is greatest in the center while reducing markedly as each end of the instrument is approached. In particular, FIG. 2 highlights a contour on the front face (90) that reduces the width of the body and allows a person to more easily reach the difficult frets closer to the sound hole. The neck may be turned slightly when mounted on the body to compliment this effect, and the face or top portion of the guitar is also contoured in a manner complementary to the skewing of the neck of the instrument. Also depicted in FIG. 2 is a contour of the back side (100) of the guitar. This contour accommodates the leg of a person holding the guitar, further allowing the guitar to conform to a person's body. FIG. 4 shows the side view of FIG. 3 of the present invention but with some additional rotation showing in greater detail the curvature of the backside of the guitar body at the neck end of the frame.

FIG. 5 shows an end view of the preferred embodiment of this invention. This view is opposite the end having the neck extending from it. In this embodiment, the contours of the front and back sides of the guitar produce a skewed or twisted shape about the long axis of the body.

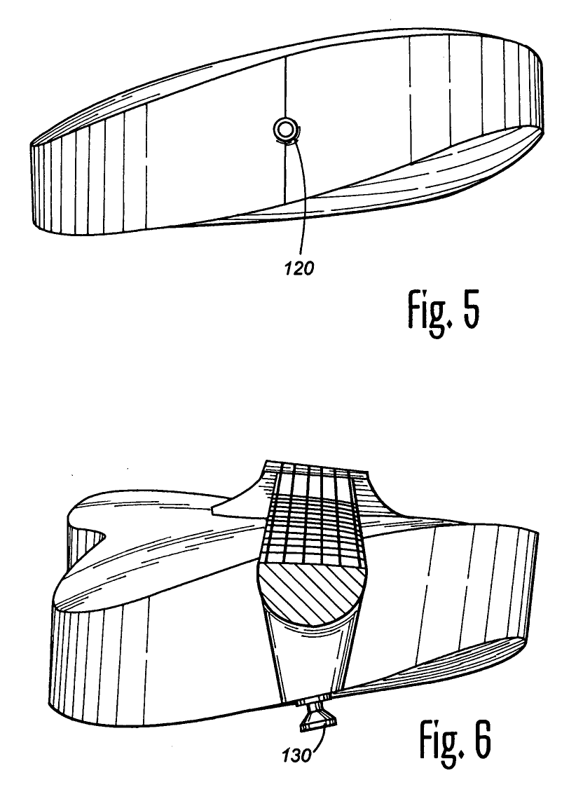

FIG. 6 shows a perspective end view of the preferred embodiment of the present invention. In FIG. 6 the end of the neck is cut away to more clearly show the contour of the body and the relationship of the string supporting surface of the neck to the front side of the guitar. In particular, the surface of the neck is not tangent to the curvature of the front face in this embodiment. As shown, the bridge is seen raised markedly on one end with respect to the guitar face, as compared to prior art devices. As shown more clearly in FIG. 1, the bridge is skewed with respect to the orientation of the strings of the guitar away from the standard perpendicular arrangement such as to provide a more appropriate anchoring of the guitar strings in light of the curvature of the guitar face. In the event that the neck of the guitar is also twisted as per the prior art Burrell '260 patent, a skewing of the bridge location away from perpendicular will be more required.

FIG. 6 also illustrates the contours present in the front and back faces of the guitar body. In use, the top face edge of the instrument is skewed such as to approach the body of the user in a much more ergonomically effective construction. Likewise, the back face of the instrument skews away from the user in order to accommodate the size of the expected user wherein it will be desirable for the guitar to somewhat couple with shape of the user, thereby lessening the reach required to play the instrument.

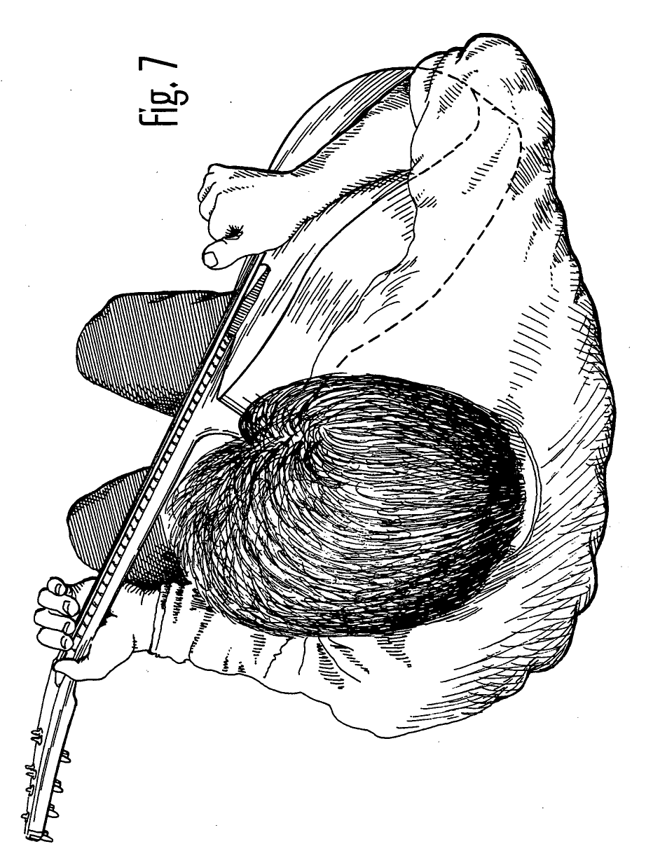

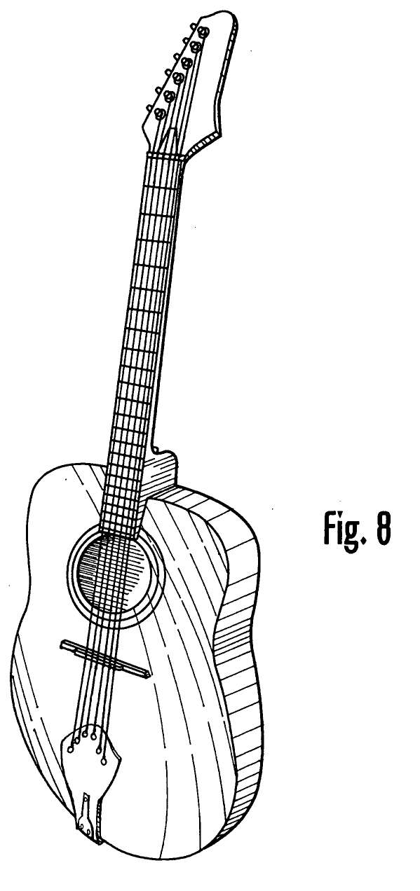

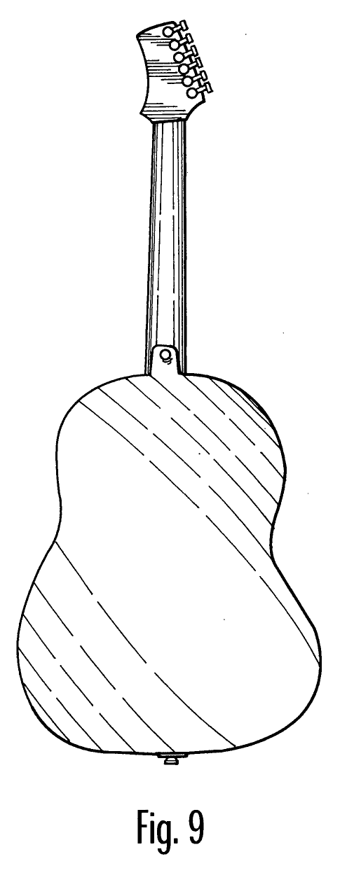

FIG. 7 shows a top view of a person holding and playing the guitar of the present invention. Referring also to FIG. 3, it can be seen that the contour at the upper back (100) of the guitar allows the guitar to have its top front edge tilted generally toward the player in FIG. 7. The contour (90) of the end away from the neck, as shown in FIG. 3, allows an easier reach to the strings by the player's right hand. This, generally, is a more ergonomic position, and, more particularly, is especially helpful for smaller persons to reach the necessary locations on the instrument. Again, a guitar as illustrated in the present embodiment could be made for a left handed person by reversing the location of the contours.

As noted above in reference to FIG. 6, it can be seen that no special relationship between the angular orientation of the neck and the front surface of the guitar is required. This allows for further ergonomic adaptation of the guitar by changing the orientation or contour of the neck as discussed in U.S. Pat. No. 4,534,260 by the present inventor, Leo L. Burrell.

1. A stringed musical instrument comprising:
a) a hollow body comprised of a contoured front face, a contoured back face oriented generally opposite said contoured front face, and a continuous side member extending around and between said front and back faces to form a hollow body;
b) an elongated neck extending from one end of said hollow body terminating in a headstock;
c) a sound aperture oriented in the central region of said contoured front face; and
d) a plurality of strings tautly oriented across said contoured front face and said sound aperture and anchored at the end of said headstock.

2. The stringed instrument of claim 1 wherein said contoured front face is generally contoured toward the user from the central region of said hollow body in the vicinity of said sound aperture to the upper right edge of said surface corresponding to the area in which the arm of a right-handed user of said instrument would rest while strumming said instrument.

3. The stringed instrument of claim 1 wherein said contoured front face is generally contoured toward the user from the central region of said hollow body in the vicinity of said sound aperture to the lower left edge of said face corresponding to the area of said front face adjacent to the intersection of said neck and said body and below the longitudinal axis of said instrument.

4. The stringed instrument of claim 1 wherein said contoured back face is generally contoured away from the user from the central region of said hollow body to the lower right edge of said face corresponding to the area of said back face on the opposite end of the instrument from said neck and below the longitudinal axis of said instrument.

5. The stringed instrument of claim 1 wherein said contoured back face is generally contoured away from the user from the central region of said hollow body to the upper left edge of said face corresponding to the area of said back face adjacent to the intersection of said neck and said body and above the longitudinal axis of said instrument.

6. The stringed instrument of claim 1 wherein the instrument is a guitar.

7. The stringed instrument of claim 1 wherein said neck of said instrument is twisted or skewed about the longitudinal axis of the guitar.

8. A stringed instrument comprising:
(a) a body, having a front side and a back side;
(b) a neck, extending from said body;
(c) strings extending across said front side of said body; wherein
(d) at least a portion of either said front side or said back side is contoured.

9. The stringed instrument of claim 8 wherein:
the opposite side contours along with said front side or said back side so that said body contours in that portion.

10. The stringed instrument of claim 8 wherein:
at the end opposite where said neck extends, said body is contoured on its front side, from the central area to the top edge, back toward a person holding said stringed instrument.

11. The stringed instrument of claim 8 wherein:
at the end where said neck extends, said body is contoured on its back side from the central area to the top edge, away from a person holding said stringed instrument.

12. The stringed instrument of claim 8 wherein:
at the end opposite where said neck extends, said body is contoured on its back side, from the central area to the bottom edge, away from a person holding said stringed instrument.

13. The stringed instrument of claim 8 wherein:
at the end where said neck extends, said body is contoured on its front side, from the central area to the bottom edge, toward a person holding said string instrument.

14. The stringed instrument of claim 8 wherein;
said contour is a smooth curve from said central area to said edge.

15. The stringed instrument of claim 8 wherein;
said contour is essentially planar from said central area to said edge.
